(19) United States
(12) Patent Application Publication
(10) Pub. No.: US 2001/0008701 A1
(43) Pub. Date: Jul. 19, 2001

(54) IMPROVED PHOTOPOLYMER FILM AND METHOD FOR PRODUCING SAME

(76) Inventors: STUART G. PATERSON, VIGO, IN (US); CARL D. RAY, VIGO, IN (US); JAMES P. DI POTO, TERRE HAUTE, IN (US); JAMES M. ADAMS, TERRE HAUTE, IN (US)

Correspondence Address: J KEVIN GRAY, JENKINS AND GILCHRIST, 1445 ROSS AVENUE, SUITE 3200, DALLAS, TX, 752022799

(21) Appl. No.: 09/053,844

(22) Filed: Apr. 1, 1998

(51) Int. Cl. B32B 27/32

(52) U.S. Cl. 428/522; 428/174; 428/63; 428/523

(57) ABSTRACT

An improved photopolymer coversheet film including no microindentations or micropitting is disclosed. One embodiment of the process for forming the improved the photopolymer coversheet film includes a modified casting (casting and coating) method. This embodiment exhibits no microindentations or micropitting in its smooth surface. Another embodiment of the process for producing the improved photopolymer coversheet film includes the use of a reheat embossing step to achieve no surface microindentations greater than 0.5 microns in depth.

### BACKGROUND OF THE INVENTION

Photopolymer laminations are used in processes ranging from the graphical arts (e.g., image forming) and solder masking to circuit board construction. When the photopolymer lamination is placed over the surface or substrate of interest and contacted by light, also known as “photoflashing” or “photodeveloping”, the polymers within the lamination react to accomplish a task, such as selectively solidifying and defining predetermined conductor patterns on a circuit board.

The printed circuit industry has experienced, and continues to experience, pressure to increase the density of circuit configurations on a single circuit board. Simultaneously, such increased density must fit on smaller and smaller circuit boards. Newer microcircuit technologies allow for the density of circuitry on circuit boards to effectively be limited only by the physical size of the circuit board. Accordingly, there have been efforts to reduce the space existing between the individual circuits on such boards (i.e., reduce the “line to line” spacing).

A significant drawback encountered by such miniaturization efforts has been the coversheets used in the production of photopolymer laminations, which are subsequently used in the production of circuit boards. Traditional prior art methods to produce such coversheets introduce microindentations (“micropits”) into the surface of such coversheets. Prior to the need for miniaturization, such micropits were tolerated since they fell in between the relatively large line to line spaces and therefore did not affect performance of the microcircuits. Today, however, such micropits effectively limit the circuit configuration density of a board and can disrupt the performance of the microcircuits, causing the board to fail.

It is known that a primary cause of micropits in the surface of embossed films, including photopolymer coversheet films, is the introduction of a layer of air between the film and the casting roll during the production of the film. During production, air travels with the rotating casting roll and tends to be trapped within the surface of the film by the nip rollers used to texturize or emboss one side of the film. Traditional methods have been developed in an attempt to reduce the amount of such air from being trapped in the surface of films. Although such traditional methods are capable of slightly reducing the number of micropits formed within the surface of the film, further reduction of micropits is crucial to the continued development of microcircuits.

Advances in film technology have produced one side smooth, one side matted (“OSM”) films. Such OSM films are more fully described in U.S. Pat. Nos. 4,895,760 and 5,100,709, both assigned to Tredegar Industries, Inc., Richmond, Va. The matte or roughened side of these advanced films prevents blocking and wrinkling of the film by precluding a measure of intimate contact between the surfaces. Use of such films as photopolymer coversheets reduces, or completely removes, the disadvantages associated with prior art films.

Thus there remains a need for an improved photopolymer coversheet film having virtually no micropitting, and a method for producing same.

### SUMMARY OF THE INVENTION

In accordance with the present invention there is provided an improved photopolymer coversheet film having a significant reduction in, or complete elimination of, the number of micropits within its surface. The improved photopolymer coversheet film of the present invention is produced in one embodiment using a reheat post embossing method. In a different embodiment, a casting and coating method is employed. Additionally, the improved photopolymer coversheet film is preferably of the OSM type so that blocking and wrinkling of the film are substantially minimized, if not completely eliminated.

The improved photopolymer film of the present invention comprises a film preferentially having a smooth side, a rough side and, optionally, one or more additional or core layers interposed between the smooth side and the rough side. The monolayer is preferably extruded and the multiple layers are preferably coextruded or tandem extruded. The smooth side comprises at least one layer of a thermoplastic film. In use, the smooth side is applied to the surface of a photosensitive composition and acts as a protective coversheet. The use of such a coversheet is necessary to facilitate the winding of the photopolymer product into rolls. The rough side is also comprised of at least one layer of a thermoplastic film. The rough side is preferably matte embossed, but can be roughened via any suitable means. The rough side prevents the film from contacting as much surface area of itself, or any other surface, preventing blocking and wrinkling of the film. At least one core layer may be interposed between the smooth side and the rough side of the improved photopolymer coversheet film, depending upon the desired application, and, if present, is also comprised of a thermoplastic film. In the monolayer embodiment, the smooth side and rough side are opposing sides of the single layer of the film.

The improved photopolymer coversheet film of the present invention is preferably composed of an olefin, and more preferably, of a polyolefin, such as polyethylene. Although polyolefins and polyethylene are identified herein as preferred materials, it is noted that any material suitable for use as a photopolymer coversheet is contemplated by the present invention.

In one embodiment of the improved photopolymer film of the present invention, the film is a monolayer film. In other embodiments of the improved film of the present invention a one, two or multilayered film is produced including the appropriate polymers for the desired application. These films can be blown or cast. Additionally, in the multilayered embodiment, the layer including the smooth side of the improved photopolymer film of the present invention may be laminated to the layer including the rough side, if desired. The blending of homopolymer and copolymer materials of the improved photopolymer coversheet film is dictated by the desired application.

According to one embodiment of the method of the present invention, the improved photopolymer coversheet film is produced by preselecting the one or more primary components comprising the one or more layers of the improved photopolymer coversheet film. It is the smooth surface of this first layer, if more than one layer is present, which will intimately contact the photosensitive composition.

The remaining skin and core layers, if present, are preferably formed of a thermoplastic. If present, the additional layers are preferably coextruded or tandem extruded to form the improved photopolymer coversheet film of the present invention. Due to the preselection of the components and their relative amounts, the resulting photopolymer coversheet film is tailored to perform in the given production environments under the given conditions for a desired application.

Once the constituent elements have been selected, the coversheet film is extruded (or coextruded, as the case may be) using traditional methods known in the art. However, instead of using traditional direct casting methods, one embodiment of the method of the present invention uses a reheat post embossing method. In this embodiment, the cast film is drawn onto a traditional polished chrome at a molten temperature and recrystallized to the solid state. Subsequently, the web is reheated to a temperature below its melting point. The softened, but not molten, web is then drawn through a rubber nip roller to impart a roughened pattern on one side of the film. Since the film is roughened or embossed at a temperature which merely softens and does not melt the web, any air trapped between the nip roller and the surface of the film will not distort the surface of the film, as is the case when the web is in a molten state. Additionally, the reheat embossing process utilizes high nip pressure which helps exclude air entrapment that produces micropits. Accordingly, very few micropits appear in the resultant film.

In another embodiment of the improved photopolymer film of the present invention, the molten web, upon exiting the slot die cast, is drawn onto a single polished chrome nip roller. The molten web is drawn onto the chrome roller using a vacuum generator or similar device used to pin the web and is recrystallized to the solid state. Since a single roller accepts the molten web from the die slot, no air is introduced into the surface of the developing film via use of a nip roller. The film is extremely smooth on both sides at this stage of its development and is allowed to cool. Subsequently, the cooled web is drawn to a second polished chrome nip roller where another layer of molten film material is extruded and laid on top of the first layer. The layers are next fed into a nip consisting of the second polished steel smooth roller and a rough ground rubber roller where the layers of the film are simultaneously fused together and one side of the film is embossed or matted. The resulting film includes no micropits within its surface because the smooth side layer is always in the solid state.

The resultant photopolymer coversheet film includes no micropits and is very smooth on one side, thus making this film ideal for use as a photopolymer coversheet for a variety of applications. For purposes of this application, “micropit” will be defined as any microindentation which is greater than 0.5 microns in depth and which is within the surface of the film contacting the photopolymer composition.

### BRIEF DESCRIPTION OF THE FIGURES

A more complete understanding of the present invention may be had by reference to the following detailed description when taken in conjunction with the accompanying figures wherein:

FIG. 1 is a flowchart outlining the steps employed in the reheat embossing embodiment of the present invention method;

FIG. 2 is a flowchart outlining the steps employed in the modified casting embodiment of the present invention method; and

FIG. 3A is a diagram representing the production line used to produce the improved photopolymer coversheet film of the present invention by the reheat embossing embodiment of the present invention method;

FIG. 3B is a diagram representing the production line used to produce the improved photopolymer coversheet film of the present invention by the modified casting embodiment of the present invention method; and

FIG. 4 is an illustration of a photopolymer lamination utilizing the improved photopolymer coversheet film of the present invention.

### DETAILED DESCRIPTION OF FIGURES

In a preferred embodiment of the improved photopolymer coversheet film of the present invention, a first layer having at least one smooth surface and a second layer having at least one rough surface and, optionally, at least one core layer are coextruded to form an improved photopolymer film for use as a photopolymer coversheet. Each of the layers is preferably comprised of a thermoplastic film. The thermoplastic films making up the layers of the improved photopolymer coversheet film of the present invention also may include films of polyolefins (homopolymers and copolymers), polyvinyl alcohol, polyvinyl chloride, nylon, polyester, polystyrene, polymethylpentene, polyoximethylene, and the like, or blends thereof. Films of polyethylene are particularly suited and therefore preferred and films of low density polyethylene homopolymers are even more particularly suited and therefore more preferred due to their relatively low flexural modulus which tends to conform better to surfaces.

The rough side of the second layer is preferably embossed to produce the desired roughness. The roughness of the second layer is important to prevent blocking and wrinkling of the masking film. The rough surface prevents blocking by precluding such intimate contact between the surfaces of the film and another surface such that the masking film can be easily unrolled and/or peeled away from another smooth surface. This feature also prevents the wrinkling so often associated with traditional relatively smooth films.

Matte embossing is a preferred technique for imparting a sufficient level of roughness to the second layer Although matte embossing has been described as a preferred technique by which the second layer is provided with roughness, it should be noted that the roughing of the surface of the second layer may be accomplished via any suitable method or means, if desired.

It is noted that although the preferred embodiment includes at least a first layer and a second layer, the relatively smooth side and the relatively rough side of the improved masking film of the present invention can be formed on opposite sides of a single layer of thermoplastic material, if desired. In such an embodiment, no core layers would be present and the process steps below would appropriately modified.

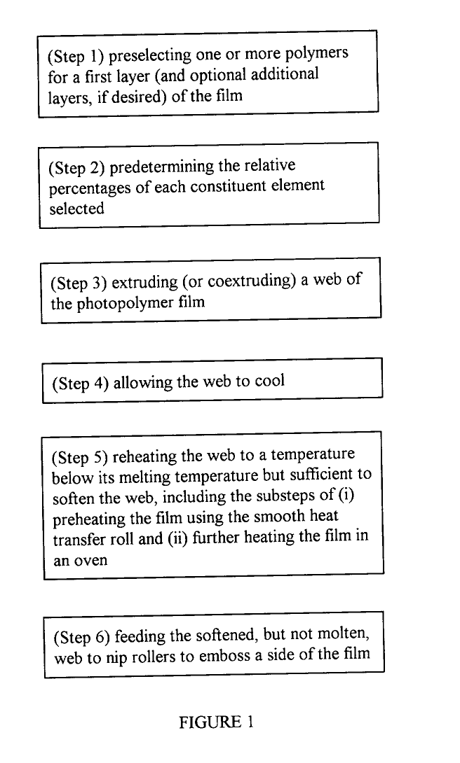

Referring now to FIG. 1, according to one embodiment of the method of the present invention, the above-identified improved photopolymer coversheet film is produced employing the steps of: (Step 1) preselecting one or more primary polymers of the at least one first layer of the film; (Step 2) predetermining the relative percentages of each constituent element selected; (Step 3) extruding (or coextruding) the web of the photopolymer coversheet film. If the film is cast, then a slot die is used during extrusion of the web. If the film is blown, a circular die is used for extrusion; (Step 4) allowing the web to cool, (Step 5) reheating the web to a temperature below its melting temperature but sufficient to soften the web. This step includes the substeps of (i) preheating the film using the smooth heat transfer roll and (ii) further heating the film in an oven; and (Step 6) feeding the softened, but not molten, web to nip rollers to emboss a side of the film. The film is then allowed to cool and is slit and wound into a roll for storage and/or transportation prior to use. The resulting photopolymer coversheet film exhibits no micropits within its surface. As previously stated, for purposes of this application “micropit” is defined as being any microindentation which is greater than 0.5 microns in depth and which is within the surface of the film contacting the photopolymer composition. Since the film is never processed by nip rollers in its molten state, the entrapment of air in the surface of the film is greatly reduced.

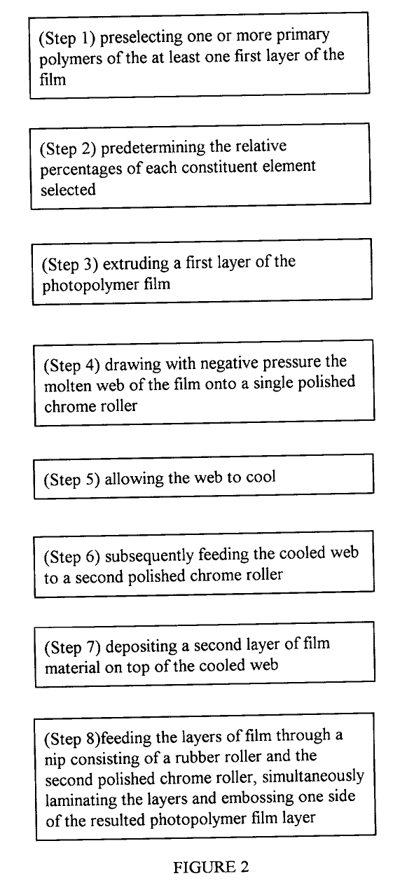

Now referring to FIG. 2, according to a different embodiment of the method of the present invention, the above-identified improved photopolymer coversheet film is produced employing the steps of: (Step 1) preselecting one or more primary polymers of the at least one first layer of the film; (Step 2) predetermining the relative percentages of each constituent element selected; (Step 3) extruding a first layer of film through a die; (Step 4) drawing with negative pressure the molten web of the film onto a single polished chrome roller; (Step 5) allowing the web to cool; (Step 6) subsequently feeding the cooled web to a second polished chrome roller; (Step 7) depositing (via extrusion) a second layer of film material on top of the cooled web; (Step 8) feeding the layers of film through a nip consisting of a rubber roller and the second polished chrome roller, simultaneously laminating the layers and embossing one side of the resulted photopolymer film layer using the rubber nip roller. The resulting film is slit and wound onto a roll for storage and/or transportation. The resultant film is completely devoid of micropits, making it ideally suited for use in photopolymer coversheet applications.

Although Applicants do not wish to be bound by this theory, it is believed that the combination of (1) the use of a single roller while the web is in its molten state; (2) the use of negative pressure to draw the molten web onto the single roller; and (3) the deposition, lamination and matting of an additional layer of film material to the cooled film web once it has cooled, act in combination to prevent the entrapment of air within the surface of the film and therefore eliminate micropitting in the improved photopolymer coversheet film of the present invention.

It is preferred that the rubber nip roller used in the method of the present invention be composed of silicone and the rubber roller used in connection with the reheat embodiment be of Hypalon® rubber, available from DuPont.

The negative pressure used to draw the web onto the rollers in the method of the present invention is preferably provided via a vacuum. Such a vacuum is provided using a vacuum box as more fully described in U.S. Pat. No. 3,145,608. Although a vacuum and a vacuum box has been described as the preferred manner in which to create negative pressure for use in connection with the present invention, it is noted that any suitable manner to draw the web into the appropriate rollers is contemplated herein.

Although cast films are primarily described herein, it is noted that traditional blown films could be used in place of the cast film described herein, if desired.

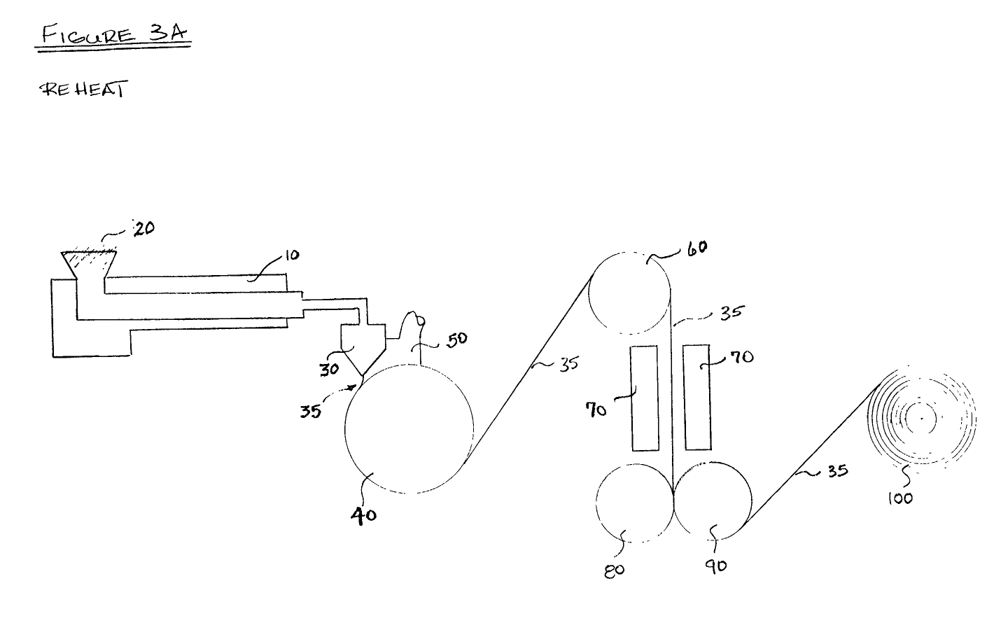

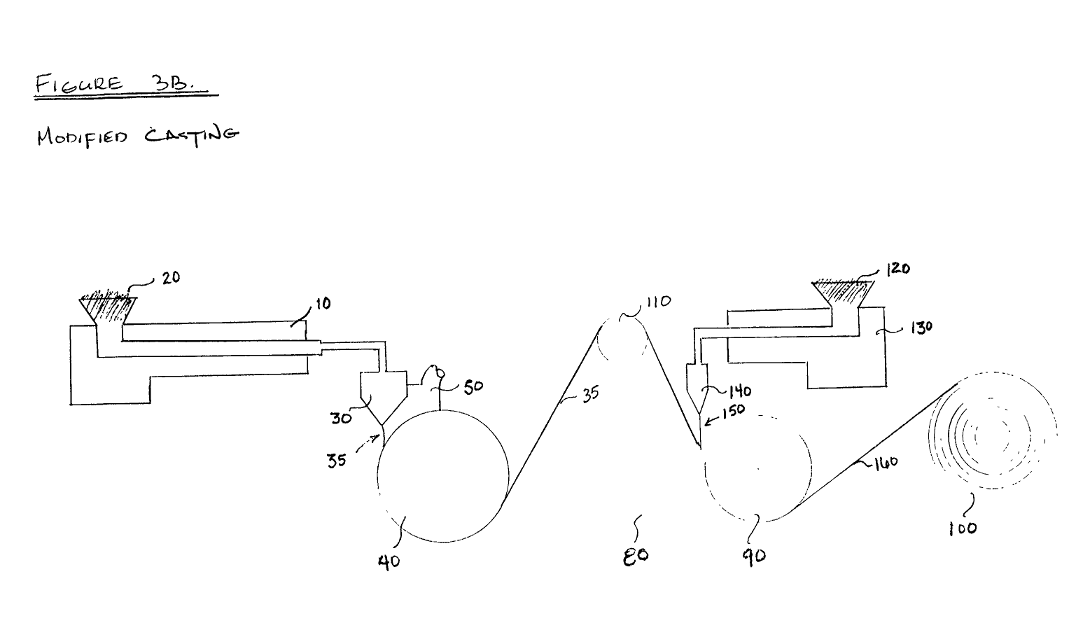

Now referring to FIGS. 3A and 3B, there are depicted diagrams of the production lines used to carry out the reheat embossing and modified cast embodiments, respectively, of the present invention method.

In FIG. 3A, the production line for the reheat embossing embodiment of the present invention method is illustrated. An extruder 10 of traditional design and function is employed to extrude the resin material 20 via a slot die 30 as a web 35. If the web 35 is cast, a traditional slot die 30 is used. If the web 35 is blown, then a circular die (not shown) is employed. The web 35 of extruded resin material 20 is drawn onto a first smooth casting roll 40 through the use of a vacuum box 50. Although a vacuum box 50 is illustrated and described herein, it is noted that the application of negative pressure via any suitable means is contemplated by the present invention.

Once the web 35 has been drawn onto the smooth casting roll 40, the web 35 is allowed to cool before it is preheated via a preheat roll 60. The web 35 is further heated via ovens 70 to a temperature below its melting point before it is embossed between rubber roll 80 and second smooth roll 90. The resultant film is finally cut and wound onto roll 100 for storage and/or transportation prior to use.

Now referring to FIG. 3B, the production line for the modified casting embodiment of the present invention method is illustrated. In FIG. 3B, wherein like elements are designated with like reference numerals, the resin material 20 is again fed to an extruder 10 and extruded using a slot die 30. The web 35 is again drawn onto the first smooth casting roll 40 using negative pressure produced from a vacuum box 50. Next, the web 35 is passed to an idler roll 110 where it is cooled. Then, a second resin 120 is extruded onto the web 35 using a coating extruder 130 and a second slot die 140 to form a coating film 150. The resultant film 160 (formed by web 35 and coating film 150) is embossed between rubber roll 90 and second smooth roll 80. Finally, the resultant film 160 is cut and wound onto a roll 100 for storage and/or transportation prior to use

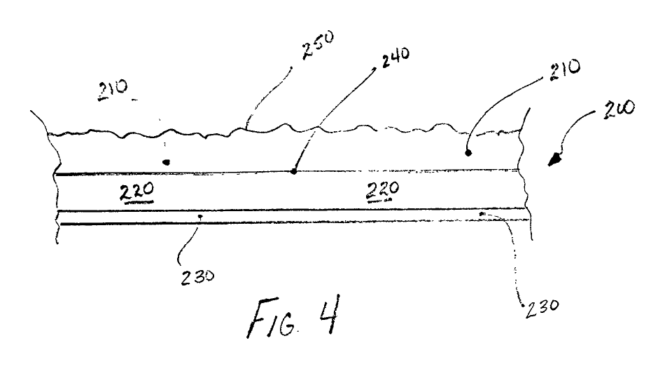

Now referring to FIG. 4, there is shown a photopolymer lamination 200 utilizing the improved photopolymer coversheet film 210 of the present invention A photopolymer 220 is sandwiched between a carrier sheet 230 and the improved photopolymer coversheet film 210 of the present invention. In this embodiment, the improved photopolymer coversheet film 210 is comprised of low density polyethylene. The carrier sheet 230 is comprised of polyester. The improved photopolymer coversheet film 210 includes a smooth side 240 and a roughened side 250. The smooth side 240 is in intimate contact with the photopolymer 220. The roughened side 250 of the improved photopolymer coversheet film 210 is directed to the outside of the photopolymer lamination 200 so as to prevent wrinkling and blocking of the photopolymer lamination 200.

In use, the protective coversheet 210 is removed and the photopolymer 220 is laminated to the surface or substrate of interest and contacted by light (“photoflashing” or “photodeveloping”). Upon contact with light, the photopolymer 220 within the lamination 200 reacts to accomplish a task, such as selectively solidifying and defining predetermined conductor patterns on a circuit board.

Films formed from the reheat embossed embodiment of the present invention were tested along with standard OSM photopolymer films to demonstrate the significant reduction of micropitting found within the surface of the photopolymer films of the present invention. The testing was conducted according to the following procedure. Standard OSM photopolymer coversheet films were prepared according to methods known in the art. The improved photopolymer coversheet film of the present invention was prepared according to the foregoing specification and using the production line illustrated and described in FIG. 3A. Subsequently, the films were examined with a Zygo® NewView 200™ Scanning White Light Interference Microscope (SWLI) to measure the depths of microindentations with the surfaces of the traditional and present invention films. The 20X Mirau objective lens was used along with the Zoom Option to measure such micropitting. Specifications for the 20X Mirau lens are listed below:

| | | | Lateral | |
|---|---|---|---|---|
| Power | Magnification | Work Distance | Resolution | Field of View |
| 20 X | 400 X | 7.4 mm | 0.88 μm | 0.32 × 0.24 |

Data from the SWLI microscope was collected from a CCD camera and processed in a Hewlett Packard® 700 Series system controller. Phase relationships of individual components of the white light spectrum are analyzed using Zygo's frequency domain analysis. Measurements made with the SWLI microscope have one (1) angstrom resolution over long vertical distances up to 5 mm and large fields of view up to 5.6 mm. The tests were conducted at room temperature (68° F.) and a humidity of 64%. The samples were prepared for microscopic inspection and measurement using no special preparation method. The results of the tests appear below in tabular form. Samples A and B represent traditional OSM photopolymer coversheet films and Samples C and D represent samples of the reheat embossed embodiment of the improved photopolymer coversheet films of the present invention.

TABLE 1

| | Min. Depth | Max. Depth | Mean Depth | Standard Dev. |
|---|---|---|---|---|
| Sample | (μm) | (μm) | (μm) | (μm) |
| A | 0.774 | 2.215 | 1.040 | 0.310 |
| B | 0.769 | 2.090 | 1.208 | 0.354 |
| C | 0.127 | 0.233 | 0.155 | 0.028 |
| D | 0.129 | 0224 | 0.147 | 0.027 |

TABLE 2

| | Min. Area | Max. Area | Mean Area | Standard Dev. |
|---|---|---|---|---|
| Sample | (μm²) | (μm²) | (μm²) | (μm²) |
| A | 4 | 157 | 58 | 38 |
| B | 4 | 277 | 113 | 79 |
| C | 4 | 144 | 50 | 39 |
| D | 4 | 128 | 29 | 37 |

As is clearly demonstrated by the foregoing tables, both the depths and area of micropits within the surface of traditional photopolymer coversheet films are substantially greater than microindentations found within the improved photopolymer coversheet films of the present invention Indeed, with respect to micropit depth, the maximum depth of microindentations found in the samples of the improved photopolymer coversheet films (0.233 μm) was approximately three times less than the minimum depth of micropits within the surface of traditional photopolymer coversheet films Importantly, the microindentations found within the improved photopolymer coversheet films are so small as to not interfere with the use of such films as a coversheet for photopolymer compositions. In other words, the microindentations of the improved photopolymer coversheet films of the present invention do not adversely affect the performance of the film as a coversheet, thus effectively rendering the film devoid of micropits.

Importantly, the modified casting (casting and coating) embodiment of the improved photopolymer coversheet films of the present invention is not listed in the tables set forth above because upon initial microscopic inspection of films prepared according to this embodiment, no micropits were observed within the surface of the film. Accordingly, no micropit measurements were possible.

Although preferred embodiments of the invention have been described in the foregoing Detailed Description, it will be understood that the invention is not limited to the embodiments disclosed, but is capable of numerous rearrangements and modifications of parts and elements without departing from the spirit of the invention.

What is claimed is:

1. An improved photopolymer coversheet, comprising:
a first side,
a second side;
said first side having a substantially smooth surface; and
said substantially smooth surface of said first side lacking microindentations therein greater than 0.5 micrometers in depth.

2. The photopolymer coversheet of claim 1, wherein the second side is substantially roughened.

3. The photopolymer coversheet of claim 2, wherein the roughened surface of the second side is embossed.

4. The photopolymer coversheet of claim 2, wherein the roughened surface of the second side is matte embossed.

5. The photopolymer coversheet of claim 1, wherein the photopolymer coversheet is composed of a thermoplastic film.

6. The photopolymer coversheet of claim 5, wherein the thermoplastic film includes polyolefins (homopolymers and copolymers), polyvinyl alcohol, polyvinyl chloride, nylon, polyester, polystyrene, polymethylpentene, polyoximethylene, or blends thereof.

7. The photopolymer coversheet of claim 5, wherein the thermoplastic film is a polyethylene homopolymer.

8. The photopolymer coversheet of claim 7, wherein the polyethylene homopolymer is of a low density.

9. An improved photopolymer coversheet, comprising:
a first side;
a second side;
said photopolymer coversheet comprised of one or more thermoplastics;
said first side having a substantially smooth surface,
said second side having a substantially roughened surface; and
said substantially smooth surface of said first side lacking microindentations therein greater than 0.5 micrometers in depth.

10. An improved photopolymer coversheet, comprising
a first layer including a first side;
a second layer including a second side,
said first layer extruded and allowed to cool to a temperature below its melting point before said second layer is extruded and joined with said first layer;
said first side having a substantially smooth surface; and
said substantially smooth surface of said first side lacking microindentations

11. The improved photopolymer coversheet of claim 10, wherein the first layer and the second layer are joined together and a surface of the second layer is roughened.

12. The improved photopolymer coversheet of claim 11, wherein the joining and roughening is accomplished via a rubber nip roll.

13. The improved photopolymer coversheet of claim 11, wherein the surface of the second layer is roughened via embossing.

14. The improved photopolymer coversheet of claim 10, wherein the first side and the second side are opposing sides of a single layer of material.

15. An improved photopolymer coversheet, comprising:
a first side, having a surface;
a second side;
said surface of said first side lacking microindentations therein greater than 0.5 micrometers in depth.

16. The improved photopolymer coversheet of claim 15, wherein the second side includes a roughened surface.

17. The improved photopolymer coversheet of claim 16, wherein the roughened surface of the second side is roughened via embossing.

18. The photopolymer coversheet of claim 15, wherein the photopolymer coversheet is composed of a thermoplastic film selected from the group consisting of polyolefins (homopolymers and copolymers), polyvinyl alcohol, polyvinyl chloride, nylon, polyester, polystyrene, polymethylpentene, polyoximethylene, and blends thereof.

19. The photopolymer coversheet of claim 18, wherein the thermoplastic film is a polyethylene homopolymer.

20. The photopolymer coversheet of claim 19, wherein the polyethylene homopolymer is of a low density.
